(19) United States
(12) Patent Application Publication
(10) Pub. No.: US 2007/0123173 A1
(43) Pub. Date: May 31, 2007

(54) Monitoring protection and control system

(76) Inventor: Anatoli Stobbe, Barsinghausen (DE)

Correspondence Address: WILLIAM COLLARD;COLLARD & ROE, P.C., 1077 NORTHERN BOULEVARD, ROSLYN, NY, 11576, US

(21) Appl. No.: 11/605,048

(22) Filed: Nov. 28, 2006

(30) Foreign Application Priority Data
Nov. 29, 2005 (DE) 10 2005 056 852.1

(51) Int. Cl. H04B 17/00

(52) U.S. Cl. 455/67.11; 455/41.2

(57) ABSTRACT

A monitoring protection and control system is described. It consists of at least one check point having a data carrier that has an identifier and can be queried by a noncontact method, also consisting of a control center for acquisition of the identifier of the queried data carriers, said identifier having been stored and read by a data collector, and also a data collector for reading and storing the identifier. The data collector has a communications interface consisting of at least one transceiver in the HF, UHF or VHF range arranged in the data collector. An external transceiver in the HF, UHF or VHF range is connected permanently or temporarily to the control center either directly or via a network or via another wireless network.

The invention relates to a monitoring protection and control system according to the preamble of Claim 1.

With a control system known from DE 34 20 100 C2, a data collector is provided for noncontact reading of data carriers at check points that have identifiers. The identifiers that are read are stored temporarily in a memory in the data collector and transmitted over a composite cable to a wireless device carried by the security personnel, said wireless device then transmitting the identifiers by wireless transmission to a control center.

In parallel with that, the identifiers of the check points are provided with a time and date stamp and stored in a memory of the data collector. This information must be saved even if there is no wireless contact during a monitoring cycle and the identifiers of the check points that have been checked in the meantime can be transmitted from the wireless device to the control center only if there is renewed wireless contact with the control center. By transmitting the identifiers by wireless transmission, it is also possible to monitor the security personnel themselves and trigger an alarm in the event of any irregularity, e.g., in the event of an attack on the security personnel, auxiliary forces can be alerted.

The connecting cable between the data connector and the wireless device contains not only data lines but also AF lines for a remote microphone, lines for a transceiver circuit and for a power supply. Current multistrand shielded cables are relatively thick and are susceptible to breakage accordingly, because on reaching a check point, the data collector, which the security personnel usually carry on their belts, must be carried to the check point.

To establish a balance between data stored in the data collector and data transmitted by wireless transmission after a monitoring cycle, the data collector is connected directly to the data processing system in the check point via the cable in order to transmit the data. Another disadvantage is that the plug contacts on the cable must be disconnected from the wireless device and connected to the data processing system and vice versa. Contacts of any type are exposed to wear and soiling and then they themselves form a potential source of interference in addition to the risk of breakage of the cable.

The object of the invention is to design a data collector for a monitoring protection and control system so that communication with an external wireless device or a data processing system can be accomplished in a noncontact procedure.

This object is achieved with a monitoring protection and control system according to the preamble of claim 1 through the features of this claim.

Advantageous embodiments and refinements are derived from the subclaims.

Due to the inventive design, communication between the data collector and the data processing system at the end of a monitoring cycle is performed via the communications interface via an electromagnetic transmission route for the purpose of data emptying // data purging via the communications interface. The data collector therefore comprises a built-in transceiver that operates in the HF, UHF or VHF range and communicates with an external transceiver in the HF, UHF or VHF range. The external transceiver can be connected to the data processing system either permanently or temporarily, directly or via a network or via another wireless network.

The communications interface is also used during the monitoring cycle to transfer data from the data collector to the control center either directly or via an intermediate landline network dial-up connection or an alarm system connected to the control center or via a wireless device carried by the security personnel. There is therefore no need for a cable connection between the data collector and the external peripheral device, whether it is a data processing system or a wireless device. This avoids the risk of cable breakage or contact problems with the plug connectors.

The communications interface may be a Bluetooth interface, in which case the external transceiver will be a Bluetooth transceiver or a data processing system of the control center or a mobile wireless device connected to the control center via a mobile wireless network. As an alternative, the communications interface may also be a wireless LAN interface, in which case the external transceiver will be a wireless LAN transceiver of a network connected to a data processing system of the control center. In addition, the communications interface may be a UHF interface of a lower power level in the range of 433 MHz or 868 MHz, whereby the external transceiver may be a 433 MHz or 868 MHz transceiver, which is in turn connected to the control center via an operational wireless device.

According to another embodiment, position beacons with an HF, UHF or VHF transmitter whose position identifiers can be acquired by the data memory via the communications interface may be set up in or near individual check points.

Due to this addition, site information about the monitoring cycle of the security personnel can be acquired and saved without requiring the acquisition of identifiers of the check points.

The data carrier is preferably an RFID chip because it can be queried in a noncontact procedure and is also suitable for triggering the data collector in a noncontact procedure.

The monitoring protection and control system may additionally comprise a mobile event data carrier which is carried by the security personnel and comprises a plurality of predetermined event data which are sent by the security personnel to the reading head by manual selection and are read by the reading head in the data collector.

Such events may include information, e.g., window open, door open, machine on, light on, heating off, or it may also be an emergency call. It is thus possible to select different standardized events selectively without keypad input and acquire this information via the reading head.

Likewise, commands for control of the data collector functions can be implemented in a noncontact procedure, i.e., without a mechanical keypad or other auxiliary means such as docking stations for downloading data. This may be performed by means of special command check points with command data carriers in a manner similar to that used with events. Addressing the devices that are capable of communicating with the data collector via interfaces is also possible through such commands. In addition, operating modes can be turned on and off by command check points. These may be timer monitoring functions or alarm functions for the purpose of protecting the guard personnel.

The data collector may include a power-saving and data carrier identifier circuit by means of which at least the processor can be switched to a power-saving mode in pauses between readings and can be switched to an operating mode on detection of data carriers.

In this way, high-power-consuming modules of the data collector can be turned off temporarily and may be operated only as needed, thereby increasing the lifetime of the batteries used to supply power and/or reducing the size of the data collector and thus also the size of the battery for a given operating time.

In addition, the transceiver of the communications interface may be switched to a power-saving mode in pauses between readings and switched to an operating mode on detection of data carriers.

This also allows a substantial reduction in power consumption.

In addition, identifiers stored temporarily by the processor can be transmitted by blocks to the control center only after several reading operations or only on reaching marked check points.

In addition to saving power in the mobile sending and transmitting devices carried by the security personnel, the transmission costs are thus also reduced in the case of cost-dependent // billable transmissions via mobile wireless.

Identifiers and data may be transmitted as short messages over a mobile wireless network to the control center.

Furthermore, the data collector may additionally be designed as an RFID data carrier readable by an access reader in a noncontact procedure.

For the case when the security personnel must open access-secured doors, for which proof of authorization is usually required, this function may also be performed by the data collector itself, so that it is not necessary to carry a separate authorization ID.

The data collector may additionally comprise a microwave detector consisting of a receiver circuit and a thermal indicator connected to the receiver circuit.

It has been found that data collectors are occasionally manipulated by security personnel to simulate monitoring cycles that have not been performed properly or at all.

It is known that to destroy data collectors without any perceptible external housing damage, they may be exposed to microwave radiation in a microwave oven, for example, in which the housing remains undamaged but the electronics are destroyed. By means of a microwave detector consisting of a receiver circuit and a thermal indicator connected to the receiver circuit, preferably accommodated in the housing wall, externally perceptible damage is created, thus making it possible to detect manipulation using microwave radiation.

The present invention is explained below on the basis of an exemplary embodiment which is shown in the drawing.

In the drawing:

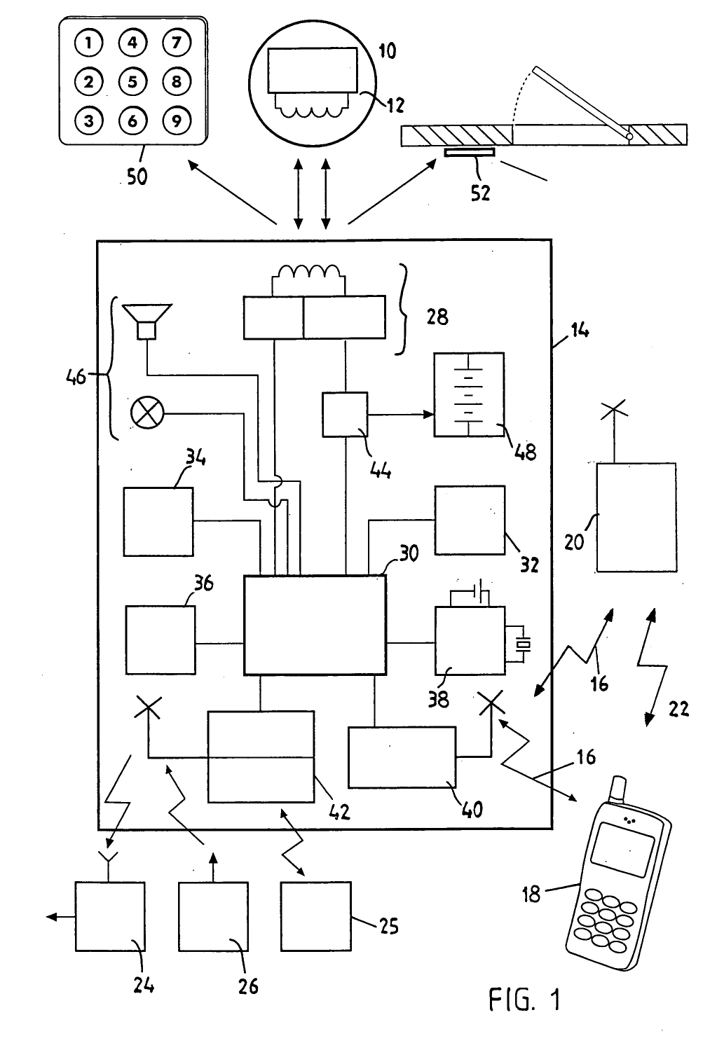

FIG. 1 shows a monitoring protection and control system having a data collector as a block circuit,

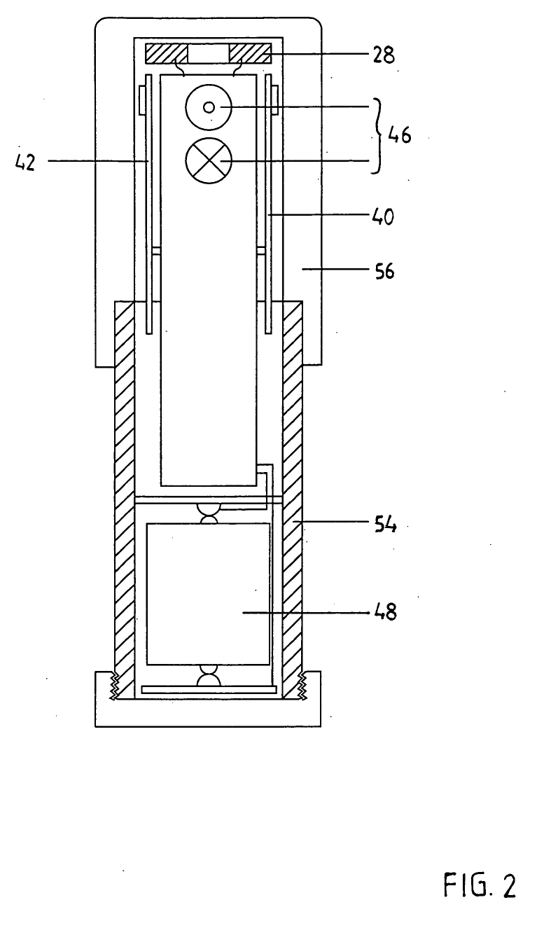

FIG. 2 shows a section through a data collector and

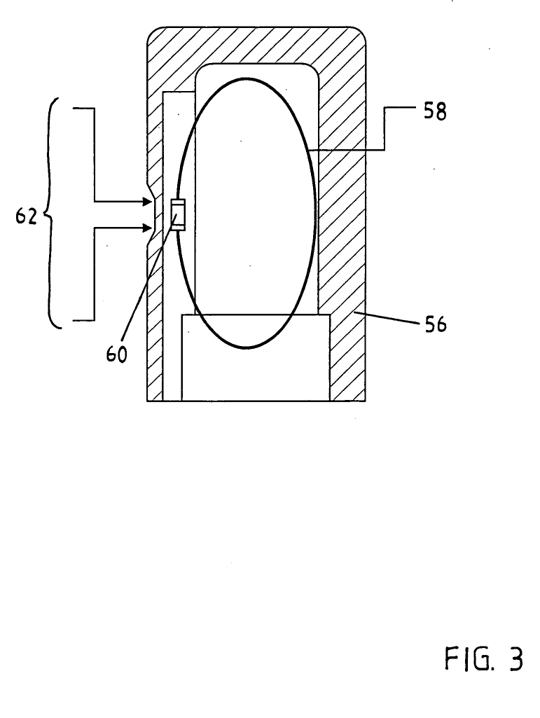

FIG. 3 shows an arrangement of a microwave detector.

FIG. 1, shows a monitoring protection and control system having a check point 10, a data collector 14 and a control center 20. The check point 10 comprises a data carrier 12 which can be queried in a noncontact procedure and has an identifier, designed here as an RFID data carrier.

The data collector 14 includes a reading head 28 having an antenna and a transceiver. The reading head 28 is connected to a processor 30 with which the identifier of the data carrier 12 of the check point 10 that can be queried in a noncontact procedure is analyzed and stored in a memory 32 in such a way that it is linked to a time code of a clock 38.

Furthermore, a transceiver 40 of a Bluetooth interface and a UHF transceiver 42 of a low power for the 868 MHz range and the VHF range are controlled by the processor 30 in the manner of a wireless LAN. The data saved can be unloaded // discharged // purged in a noncontact procedure via an external transceiver of an interface or exclusively a receiver 24 of a data processing system of the control center. Such receivers 24 may be situated in the vicinity of check points 10. There is also the possibility of performing the transmission via a wireless LAN network 25. Furthermore, via an external transceiver of a Bluetooth interface 16 of a mobile wireless device 18, data can be transmitted via a mobile wireless network 22 to the control center 20. Furthermore, data can also be transmitted directly to the control center 20 via a Bluetooth interface 16′.

In addition to acquisition of identifiers via the reading head 28, identifiers can also be transmitted by the positionlocation beacons 26 via the wireless interface and saved without having to bring the data collector 14 to a data carrier 12 of a check point 10 for this purpose.

Acquisition and storage of data and external transmission to the control center 20 can also be signaled by an optical and acoustic display 46 controlled by the processor.

In transmission of data to the control center 20 via a wireless interface, data of the identifier may additionally be transmitted with concordance data saved in another memory 34 as plain text for the location of the check point 10 to facilitate identification of the current location of the security personnel. For example, this may also be done in the form of a short message via a mobile wireless network 22.

To save power for operation of the internal transceiver and the cost of transmission via a mobile wireless network, initially multiple identifiers can be stored and then transmitted in blocks.

The data collector comprises a power-saving and data carrier recognition circuit 44 by means of which the at least one processor 30 can be switched to a power-saving mode during pauses in reading and to an operating mode on detection of data carriers. In power-saving mode, the power supply of high-power-consuming components from an internal battery 48 is interrupted. On switching to an operating mode, at the same time the data that has been read is saved in the memory 32 and optionally transmission of data to the control center 22 is initiated. The data collector may therefore be operated without any mechanical operating elements.

Different events can be compiled, saved or transmitted via mobile event data carrier 50 carried by the security personnel and having a plurality of predetermined event data, likewise without any mechanical operating elements. The event data can be selected manually by the security personnel by sending marked fields of the event data carrier 50 on which are arranged RFID data carriers having different event identifiers to the reading head 28.

Finally, the data collector 14 may also be an RFID data carrier readable by an access reader 52 in a noncontact procedure, its identifying data and address data and destination data being saved in another memory 36 connected to the processor in establishing a link to other devices.

FIG. 2 shows a section through a data collector. The housing consists of a metal section 54 and a plastic section 56. The battery 48 and the electronic circuits as well as the processor, the memories and the clock are arranged in the metal section 54 while the antenna of the reading head 28 and the modules of the transceiver 40, 42 with their antennas are arranged in the plastic section 56.

FIG. 3 shows a microwave detector consisting of a receiver circuit 58 tuned to a microwave frequency of approx. 2.45 GHz and a thermal indicator 60 connected to the receiver circuit 58. The indicator 60 is situated at a particularly thin location 62 in the plastic wall of the housing and allows the plastic wall to be melted, deformed or broken open under the influence of microwave radiation, creating a defect in the housing. This makes manipulation due to the influence of microwave radiation easily detectable.

1. A monitoring protection and control system having at least one check point which has a data carrier that can be queried in a noncontact procedure and has an identifier of the queried data carriers of the check point, a control center for acquisition of the identifier read and stored by a data collector, and also a data collector for reading and for storage of the identifier of the queried data carriers of the check point and for communication with the control center, whereby the data collector has at least one identifier reader, a processor, at least one memory, a clock, a power source and at least one communications interface, wherein the communications interface consists of at least one transceiver in the HF, UHF, or VHF range, arranged in the data collector, and at least one external transceiver in the HF, UHF, or VHF range, whereby the external transceiver is permanently or temporarily connected to the control center via a network or via another wireless network.

2. The monitoring protection and control system according to claim 1, wherein the communications interface is a Bluetooth interface, whereby the external transceiver is a Bluetooth transceiver of a data processing system of the control center or a mobile wireless device connected to the control center via a mobile wireless network.

3. The monitoring protection and control system according to claim 1, wherein the communications interface is a wireless LAN interface whereby the external transceiver is a wireless LAN transceiver of a network connected to a data processing system of the control center.

4. The monitoring protection and control system according to claim 1, wherein the communications interface is a UHF interface of a lower power in the 433 MHz or 868 MHz range, whereby the external transceiver is a 433 MHz or 868 MHz transceiver that is in turn connected to the control center directly or via an intermediate connection of a landline network dial-up connection or an alarm system connected to the control center or via an operating wireless device.

5. The monitoring protection and control system according to claim 1, wherein position beacons with an HF, UHF or VHF transmitter are arranged on or in the vicinity of individual check points, their position identifiers being acquirable by the data collector via the communications interface.

6. The monitoring protection and control system according to claim 1, wherein the data carrier is an RFID chip.

7. The monitoring protection and control system according to claim 1, wherein the monitoring protection and control system additionally comprises a mobile event data carrier that is carried by the security personnel and has a plurality of predetermined event data, said data being suppliable to the reading head by the security personnel in a manually selectable manner and readable by means of the reading head in the data collector.

8. The monitoring protection and control system according to claim 1, wherein the monitoring protection and control system additionally comprises at least one command check point by means of which data collector functions are controllable in a nonconduct procedure.

9. The monitoring protection and control system according to claim 1, wherein the data collector comprises a power-saving and data carrier detection circuit by means of which at least the processor can be switched to a power-saving mode in reading pauses and to an operating mode on detection of data carriers.

10. The monitoring protection and control system according to claim 9, wherein in addition to the transceiver, the communications interface can be switched to a power-saving mode in reading pauses and to an operating mode on detection of data carriers.

11. The monitoring protection and control system according to claim 1, wherein identifiers stored temporarily by the processor can be transmitted by blocks to the control center only after several reading operations or only on reaching marked check points.

12. The monitoring protection and control system according to claim 11, wherein data from position beacons can additionally be transmitted by blocks together with the identifiers.

13. The monitoring protection and control system according to claim 1, wherein identifiers and data can be transmitted as short messages to the control center via a mobile wireless network.

14. The monitoring protection and control system according to claim 1, wherein the data collector is additionally an RFID data carrier that can be read by an access reader in a noncontact procedure.

15. The monitoring protection and control system according to claim 1, wherein the data collector comprises a microwave detector consisting of a receiver circuit and a thermal indicator connected to the receiver circuit.

16. The monitoring protection and control system according to claim 15, wherein the indicator is arranged in or on the wall of the housing of the data collector and a housing defect can be triggered simultaneously by the response of the indicator.
